(19) United States
(12) Patent Application Publication
(10) Pub. No.: US 2014/0280968 A1
(43) Pub. Date: Sep. 18, 2014

(54) DATA CENTER AND METHOD FOR PROVIDING VIRTUAL SERVICE

(71) Applicant: HON HAI PRECISION INDUSTRY CO., LTD., New Taipei (TW)

(72) Inventors: YU-CHUNG LIN, New Taipei (TW); CHIH-YUAN HUANG, New Taipei (TW)

(73) Assignee: HON HAI PRECISION INDUSTRY CO., LTD., New Taipei (TW)

(21) Appl. No.: 14/185,114

(22) Filed: Feb. 20, 2014

(30) Foreign Application Priority Data
Mar. 14, 2013 (TW) 102108937

(51) Int. Cl. H04L 12/911

(52) U.S. Cl. CPC H04L 47/70
USPC 709/226

(57) ABSTRACT

A data center provides virtual services for a client device via a gateway. The data center includes a database and plurality of virtual machines configured for providing different virtual services for the client device. The client device communicates with the data center through a gateway. When a user registers a virtual service from the data center using the client device, the data center acquires data set by the user for describing the registered virtual services. The data set by the user includes a tag of the virtual service and login information of the user used to access the data center. When the user need to use a corresponding virtual service, the data center starts a virtual machine that provides the corresponding virtual service, and then activates the corresponding virtual service according to the tag of the corresponding virtual service.

### BACKGROUND

1. Technical Field

Embodiments of the present disclosure relate to a data center and method for providing virtual services for users.

2. Description of Related Art

Data centers consisting of one or more servers are widely used to provide virtual services for users. In a typical method for the data center to provide virtual services, basic information such as domain name and network address of the virtual services must be remembered by the user to access the virtual services provided by the data center. However, this method is inconvenient. Therefore, there is room for improvement in the art.

### BRIEF DESCRIPTION OF THE DRAWINGS

FIG. 1 is a schematic block diagram illustrating one embodiment of a data center communicating with a client device via a gateway.

FIG. 2 is a flowchart of one embodiment of a method for providing virtual services to the client device using the data center of FIG. 1

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

FIG. 1 is a schematic block diagram illustrating one embodiment of a data center 100 communicating with a client device 300 via a gateway 200. The data center 100 includes a virtual resource description (VRD) unit 101, a network controller 102, a user location unit 103, a virtual machine (VM) starting unit 104, a virtual service activation unit 105, a database 110, and a plurality of VMs 120. Each VM 120 is configured to provide different virtual services for the client device 300. A user can access the data center 100 using the client device 300 and register virtual services provided by the data center 100.

In this embodiment, the VRD unit 101, the network controller 102, the user location unit 103, the VM starting unit 104, the virtual service activation unit, the database 110, and the plurality of VMs 120 of the data center 100 can be hardware components or software components which are directly or indirectly communicating with each other for data exchange or transmission. FIG. 1 shows one embodiment of the data center 100 including more or fewer components than those shown in the embodiment, or have a different configuration of the components. The data center 100 can be a server. The client device 300 can be a personal computer, a portable device, a smart phone, or a tablet computer. The gateway 200 can be a router or a modem.

FIG. 2 shows a flowchart of one embodiment of a method for providing virtual services to the client device 300 using the components of the data center 100 of FIG. 1. Depending on the embodiment, additional steps may be added, others removed, and the ordering of the steps may be changed.

In step S1, when the user registers a virtual service (e.g., virtual desktop) from the data center 100, the VRD unit 101 acquires data set by the user for describing the virtual service, and generates VRD information of the virtual service using the data set by the user. The VRD unit 101 converts the VRD information into virtual broadcast domain (VBD) data corresponding to the user and stores the VBD data in the database 110.

The data set by the user includes a tag of the virtual service and login information (e.g., username and password) of the user to access the data center 100. For example, the tag may be a keyword, such as “Notes” or “Virtual Desktop” which is an identification of the virtual service registered by the user. The virtual service registered by the user is provided by the VM 120. In this embodiment, the VRD unit 101 provides a user interface (e.g., a webpage) for the user to set the data.

In step S2, the network controller 102 detects whether the user accesses the data center 100 using the client device 300. In this embodiment, the user can access the data center 100 using the client device 300 according to the login information to use the registered virtual service provided by the data center 100.

In step S3, when the user accesses the data center 100, the user location unit 103 acquires the login information of the user (e.g., the username and the password), acquires the VBD data corresponding to the user from the database 100 according to the login information, and transmits the VBD data of the user to the VM starting unit 104.

In step S4, the VM starting unit 104 obtains the VRD information of the virtual service according to the obtained VBD data corresponding to the user, and activates a corresponding VM 120 according to the VRD information of the virtual service. In addition, the VM starting unit 104 further feedbacks a message to the gateway 200 to indicate the gateway 200 of the corresponding VM 120 is started. In this embodiment, the started VM 120 is used to provide the virtual service registered by the user using the client device 300.

In step S5, the gateway 200 receives a virtual service discovery package sent from the client device 300 by the user.

In step S6, the gateway 200 acquires the VBD data corresponding to the user from the database 110 and stores the acquired VBD data in a storage (e.g., flash memory) of the gateway 200. In the embodiment, the virtual service discovery package includes identification of the user (e.g., the username). The gateway 200 can acquire the VBD data corresponding to the user according to the identification of the user included in the virtual service discovery package.

In step S7, the gateway 200 determines which virtual service is registered by the user according to the VBD data corresponding to the user, and sends a notification message to the data center 100 to notify the data center 100 to activate the virtual service registered by the user. In this embodiment, the gateway 200 can determine which virtual service is registered by the user according to the tag of the virtual service included in the VBD data.

In step S8, the virtual service activation unit 105 receives the notification message sent from the gateway 200 and controls the started VM 120 to activate the virtual service registered by the user.

In step S9, the network controller 102 configures network parameters (e.g., bandwidth) for the activated virtual service. The user can use the virtual service provided by the data center 100.

As described above, the data center 100 can automatically start a corresponding VM 120 and activate a corresponding virtual service according to the tag of the virtual service set by the user when the virtual service is registered using the client device 300. Thus, the user does not need to remember information (e.g., domain name and network address) of the virtual service. Therefore, it is convenient for the user to use the virtual service provided by the data center 100.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A data center for providing virtual services for a client device that communicates with the data center via a gateway, the data center comprising:
a database;
a plurality of virtual machines (VM), each VM providing one or more virtual services for the client device;
a virtual resource description (VRD) unit acquiring data set by a user for describing a virtual service when the user registers the virtual service from the data center, generating VRD information of the virtual service using the data set by the user, and converting the VRD information into virtual broadcast domain (VBD) data corresponding to the user and storing the VBD data in the database, wherein the data set by the user comprises a tag of the virtual service and login information of the user to access the data center;
a user location unit acquiring the login information of the user when the user accesses the data center using the login information, and acquiring the VBD data corresponding to the user from the database according to the login information;
a VM starting unit obtaining the VRD information of the virtual service according to the obtained VBD data corresponding to the user, and activating a corresponding VM according to the VRD information of the virtual service; and
a virtual service activation unit receiving a notification message sent from the gateway and controlling the started VM to activate the virtual service registered by the user according to the notification message.

2. The data center according to claim 1, wherein the VRD unit further provides a user interface to set the data.

3. The data center according to claim 1, further comprising a network controller detecting whether the user accesses the data center using the client device and configuring network parameters for the virtual service when the virtual service is activated.

4. The data center according to claim 1, wherein the notification message is sent by the gateway by:
receiving a virtual service discovery package sent from the client device;
acquiring the VBD data corresponding to the user from the database and storing the acquired VBD data in a storage of the gateway; and
determining which virtual service is registered by the user according to the VBD data corresponding to the user, and sending the notification message to the data center to notify the data center to activate the virtual service registered by the user.

5. The data center according to claim 1, wherein the tag is a keyword which is an identification of the virtual service registered by the user.

6. The data center according to claim 1, wherein the data center is a server and the gateway is a router or a modem.

7. A method for providing virtual services for a client device using a data center, the data center communicating with the client device via a gateway, the data center comprising a database and a plurality of virtual machines (VM), the method comprising:
acquiring data set by a user for describing a virtual service when the user registers the virtual service from the data center, wherein the data set by the user comprises a tag of the virtual service and login information of the user used to access the data center;
generating VRD information of the virtual service using the data set by the user;
converting the VRD information into virtual broadcast domain (VBD) data corresponding to the user and storing the VBD data in the database;
acquiring the login information of the user when the user accesses the data center using the login information;
acquiring the VBD data corresponding to the user from the database according to the login information;
obtaining the VRD information of the virtual service according to the obtained VBD data corresponding to the user;
activating a corresponding VM according to the VRD information of the virtual service; and
receiving a notification message sent from the gateway and controlling the started VM to activate the virtual service registered by the user according to the notification message.

8. The method according to claim 7, further comprising providing a user interface to set the data.

9. The method according to claim 7, further comprising:
detecting whether the user accesses the data center using the client device; and
configuring network parameters for the virtual service when the virtual service is activated.

10. The method according to claim 7, wherein the notification message is sent by the gateway by:
receiving a virtual service discovery package sent from the client device;
acquiring the VBD data corresponding to the user from the database and storing the acquired VBD data in a storage of the gateway; and
determining which virtual service is registered by the user according to the VBD data corresponding to the user, and sending the notification message to the data center to notify the data center to activate the virtual service registered by the user.

11. The method according to claim 7, wherein the tag is a keyword which is an identification of the virtual service registered by the user.

12. The method according to claim 7, wherein the data center is a server and the gateway is a router or a modem.
